(19) United States
(12) Patent Application Publication
(10) Pub. No.: US 2026/0131509 A1
(43) Pub. Date: May 14, 2026

(54) IMPROVED RETAINING DEVICE AND ASSOCIATED PRODUCTION METHOD

(71) Applicant: APLIX, Le Cellier (FR)

(72) Inventor: Thierry MARCHE, Le Cellier (FR)

(73) Assignee: APLIX, Le Cellier (FR)

(21) Appl. No.: 19/118,979

(22) PCT Filed: Oct. 4, 2023
(86) PCT No.: PCT/FR2023/051535

§ 371 Date: Apr. 7, 2025

(30) Foreign Application Priority Data
Oct. 11, 2022 (FR) FR2210401

(51) Int. Cl. B29C 43/22; A44B 18/00; B29C 41/28; B29C 43/28; B29C 43/46; B29C 43/48; B29L 31/00

(52) U.S. Cl. CPC B29C 43/222; A44B 18/0061; B29C 41/28; B29C 43/28; B29C 43/48; B29C 2043/464; B29C 2043/465; B29C 2043/486; B29L 2031/729

(57) ABSTRACT

A device including a support, having a lower face and an upper face, the support forming a strip extending along a longitudinal direction, a base extending along the longitudinal direction between a first end and a second end, the base having a lower face facing the upper face of the support, and an upper face, the base having a constant thickness between its lower face and its upper face, a plurality of retaining elements extending from the upper face of the base, wherein the base is secured to the support in a non-uniform manner, and includes at least one segment secured to the support, and at least one portion not secured to the support.

### TECHNICAL FIELD

The present invention relates to the field of retaining devices, typically of the hook and loop type.

### PRIOR ART

The methods for manufacturing hook and loop retaining elements such as hook retaining elements are usually high-speed continuous methods. The usual methods thus make it possible to produce tapes or reels comprising a base with a face from which retaining elements extend.

This tape is then cut out and afterwards secured to a support for use.

However, the elements thus obtained are rigid elements, which may lead to products that are rough or unpleasant to the touch, or even injure the user.

The present invention thus aims to address these issues, while minimizing the industrial impact.

### DISCLOSURE OF THE INVENTION

In order to at least partially address these issues, the present invention relates to a method for manufacturing a retaining device, in which:
a continuous base is formed, the base extending along a longitudinal direction, the base having a lower face and an upper face, the upper face of the base comprising a plurality of retaining elements and/or preforms for the formation of retaining elements, the base having a constant thickness between its lower face and its upper face, in particular over at least 30% of the surface of the base, or at least 40%, 50%, 60%, 70%, 80% of the surface of the base,
a support having a lower face and an upper face is provided, the support extending along a longitudinal direction, in particular extending continuously,
the support is applied on the base in particular continuously along the longitudinal direction and/or along a transverse direction so as to secure the lower face of the base on the upper face of the support in a non-uniform manner along the longitudinal direction and/or along a transverse direction perpendicular to the longitudinal direction so as to define portions of the base secured to the support, and portions of the base not secured to the support, the set formed by the support and the base forming a product.

The application of the support on the base is for example such that the length of the base extension and the length of the support extension, in the area of application of the support on the base, have a difference of less than 10%, in particular a continuous contact along the longitudinal direction and/or along a transverse direction is made between all or part of the lower surface of the base and the support.

According to one example:
the product comprising a support and a base secured in a non-uniform manner to the support is demolded,
all or part of the portions of the base not secured to the support are cut out and separated from the product.

According to one example, said cutout defines at least one edge of the base not secured to the support, and is made so as to maintain a non-zero distance between said at least one edge of the base not secured to the support and at least one adjacent portion of the base secured to the support.

According to one example, following the cutting step or simultaneously with the cutting step, the portions of the base cut out and separated from the retaining device are collected, and the material is reused so as to produce the or one base and/or the retaining element(s) and/or the preform(s).

According to one example, following the cutting step or simultaneously with the cutting step, a calendering is performed on all or part of a periphery of the segments of the base so as to secure it or confirm its securing to the support and/or for example so as to reduce its thickness.

The reduced thickness of all or part of a periphery of the segments of the base so as to secure it or confirm its securing to the support may thus not be directly derived from the formation of the base.

According to one example, a calendering of the preforms is performed so as to modify the geometry of all or part of the preforms to obtain retaining elements, in particular prior to the cutting step.

According to one example, the base is secured to the support in particular by partial penetration of the support into the base, by application of the support on the base downstream of the formation of the base, prior to securing the lower face and the base.

According to one example, the base and the support are made of different materials, especially materials of different natures.

According to one example, the support comprises fibers and/or filaments and/or threads on its upper face, for example the support comprises a web of nonwoven material.

According to one example, the support is calendered per area prior to its application on the base, the at least one calendered area of the support, in particular the calendered areas of the support, having a thickness at least 10%, preferably at least 30% smaller, the at least one non-calendered area, typically at least one area extending continuously along the longitudinal direction, in particular the non-calendered areas and a surface greater than 5 mm² , in particular at least 15 mm² , determining during the application of the support at least one area, in particular areas of greater thickness pressurized on the base which is secured to the base, and at least one calendered area, in particular calendered areas of smaller thickness which is not secured to the base.

According to one example, an upper face of the at least one non-calendered area of the support, in particular the non-calendered areas of the support, extends along a non-calendered plane and an upper face of the at least one calendered area of the support, in particular the calendered areas of the support, extends along a calendered plane distinct from the non-calendered plane, the at least one non-calendered area of the support or the non-calendered areas of the support being intended to be secured to the base and the at least one calendered area of the support or the calendered areas of the support being intended not to be secured to the base.

According to one example, the application of the support on the base is performed in a non-uniform manner, such that the lower face of the support defines:
a first set of areas in which the support is secured to the base,
a second set of areas in which the support is not secured to the base,
in which the first set of areas extends along a first plane P1 and the second set of areas extends along a second plane P2 distinct from the first plane P1, the first plane P1 being closer to the lower face of the base than the second plane P2.

The first set of areas and the second set of areas may each comprise one or more areas.

According to one example, the application of the support on the base is performed by means of a roller having solid portions adapted to apply a force tending to secure the support to the base, and hollowed-out areas, configured so as not to apply a force tending to secure the support to the base.

The present invention also relates to a device comprising:
a support, having a lower face and an upper face, the support forming a strip extending along a longitudinal direction,
a base, the base extending along the longitudinal direction between a first end and a second end, the base having a lower face facing the upper face of the support, and an upper face, the base having a constant thickness between its lower face and its upper face, in particular over at least 30% of the surface of the base, or at least 40%, 50%, 60%, 70%, 80% of the surface of the base,
a plurality of retaining elements extending from the upper face of the base, characterized in that the base is secured to the support in a non-uniform manner, and comprises at least one segment secured to the support, and at least one portion not secured to the support.

According to one example, the length of the base extension and the length of the support extension, in the area of application of the support on the base, have a difference of less than 10%, in particular a continuous contact along the longitudinal direction and/or along the transverse direction is made between all or part of the lower surface of the base and the support

The invention also relates to a device comprising:
a support, having a lower face and an upper face, the support forming a strip extending along a longitudinal direction,
a base, extending along the longitudinal direction between a first end and a second end, the base having a lower face facing the upper face of the support, and an upper face, the base having a constant thickness between its lower face and its upper face, in particular over at least 30% of the surface of the base,
a plurality of retaining elements extending from the upper face of the base, characterized in that 100% of the surface of the periphery portion is secured to the support and all or part of the periphery portion secured to the support has a thickness smaller than the thickness of an internal portion of the base.

According to one example, the length of the base extension and the length of the support extension, in the area of application of the support on the base, have a difference of less than 10%, in particular a continuous contact along the longitudinal direction and/or along the transverse direction is made between all or part of the lower surface of the base and the support.

The invention also relates to a device, the device (10) comprising:
a support, having a lower face and an upper face, the support (22) forming a strip extending along a longitudinal direction (MD),
a base (12), extending along the longitudinal direction (MD) between a first end and a second end, the base (12) having a lower face (12B) facing the upper face (22A) of the support (22), and an upper face (12A), the base (12) having a constant thickness between its lower face (12B) and its upper face (12A), in particular over at least 30% of the surface of the base,
a plurality of retaining elements (16) extending from the upper face (12A) of the base (12),
the base (12) is secured to the support (22) in a non-uniform manner, and comprises at least one segment secured to the support (S), and at least one portion not secured to the support (P),
the support comprises fibers and/or filaments and/or threads on its upper face, for example the support comprises a web of nonwoven material,
the support is calendered per area prior to its application on the base, the at least one calendered area of the support, in particular the calendered areas of the support having a thickness of less than 10%, preferably at least 30%, the at least one non-calendered area, typically at least one area extending continuously along the longitudinal direction, in particular to the non-calendered areas and a surface greater than 5 mm² , in particular at least 15 mm² , determining during the application of the support at least one area, in particular areas of greater thickness pressurized on the base which is secured to the base, and at least one calendered area, in particular calendered areas of smaller thickness which is not secured to the base.

According to one example, the lower face of the support defines:
a first set of areas in which the support is secured to the base,
a second set of areas in which the support is not secured to the base,
in which the first set of areas extends along a first plane P1 and the second set of areas extends along a second plane P2 distinct from the first plane P1, the first plane P1 being closer to the lower face of the base than the second plane P2.

The first set of areas and the second set of areas each typically comprise one or more areas.

According to one example, the base comprises a periphery portion forming an outer periphery of the base extending over a maximum distance of 3 mm, especially 2 mm, especially 1 mm, especially 0.5 mm, in which at least 3%, especially at least 5%, 7%, 10%, 15%, 20%, 25%, 30%, 35% or 45% of the surface of the periphery portion is not secured to the support and in particular has a thickness substantially equal to the constant thickness of the base and/or of the internal portion of the base.

According to one example, the base comprises a periphery portion forming an outer periphery of the base extending over a maximum distance of 3 mm, especially 2 mm, especially 1 mm, especially 0.5 mm, in which at least 3%, especially at least 5%, 7%, 10%, 15%, 20%, 25%, 30%, 35%, 45%, 50% or 60% of the surface of the periphery portion is secured to the support and has a thickness smaller than the thickness of a central portion of the base. The reduced thickness of all or part of a periphery of the base is typically not directly derived from the formation of the base.

According to one example, the base comprises a periphery portion forming an outer periphery of the base extending over a maximum distance of 3 mm, especially 2 mm, especially 1 mm, especially 0.5 mm, in which at least 50%, especially at least 55%, 60%, 65%, 70%, 75%, 80%, 85%, 90%, 95% or 100% of the surface of the periphery portion is not secured to the support, and has a thickness smaller than the thickness of an internal portion of the base, in particular the periphery portion not secured to the support has a thickness substantially equal to the constant thickness of the base and/or of the internal portion of the base.

According to one example, the base comprises a periphery portion forming an outer periphery of the base extending over a maximum distance of 3 mm, especially 2 mm, especially 1 mm, especially 0.5 mm, in which at least 50%, especially at least 55%, 60%, 65%, 70%, 75%, 80%, 85%, 90% or 95% of the surface of the periphery portion is secured to the support and all or part of the periphery portion secured to the support has a thickness smaller than the thickness of a central portion of the base. As a variant, 100% of the surface of the periphery portion is secured to the support. The reduced thickness of all or part of a periphery of the base is typically not directly derived from the formation of the base.

According to one example, the surface of the base not fixed to the support is at most 25%, 22%, 20%, 18%, or even 15%, of the total surface of the base.

According to one example, the support is devoid of pleats.

According to one example, 100% of the surface of the periphery portion is secured to the support, part being derived from calendering of the at least one portion not secured to the support, and all or part of the periphery portion secured to the support has a thickness smaller than the thickness of an internal portion of the base According to one example, the periphery portion is devoid of retaining elements.

According to one example, the periphery portion comprises retaining elements.

According to one example, the support comprises fibers and/or filaments and/or threads on its upper face, for example the support comprises a web of nonwoven material.

According to one example, the support comprises calendered areas and non-calendered areas, the calendered areas of the support having a thickness at least 10%, preferably at least 30%, smaller than the non-calendered areas and a surface greater than 5 mm² , in particular at least 15 mm² , such that an upper face of the non-calendered areas of the support extends along a non-calendered plane P1′ and an upper face of the calendered areas of the support extends along a calendered plane P2′ distinct from the non-calendered plane P1′, the non-calendered areas of the support being secured to the base and the calendered areas of the support not being secured to the base. The support may typically comprise one or more calendered areas and one or more non-calendered areas.

According to one example, the base is secured to the support by partial encapsulation of the support in the base.

According to one example, the base and the support are made of different materials, especially materials of different natures.

According to one example, the base has a variable width along the transverse direction.

According to one example, the base is included in an area delimited by two parallel straight lines extending along the longitudinal direction, and in which an occupancy rate of the base in this area is strictly less than 100%, preferably less than 95%, especially less than 80% and/or greater than 5%, especially greater than 15%, more particularly greater than 35%, in other cases greater than 55%.

According to one example, a maximum dimension of the base along a row along the longitudinal direction is strictly smaller than the maximum dimension of the support along the longitudinal direction.

According to one example, the support comprises at least one notch or cutout formed in a portion of the support distant from the edges of the support, the at least one notch or cutout being able in particular to be formed in the support on the periphery of the edge of the base, particularly at more or less 3 mm from the border of the base, in particular at more or less 2 mm from the border of the base.

According to one example, the device comprises a reference means for the cutting, for example a marking, a hole, an embossing and/or an ink layer.

The present invention also relates to a system comprising a device as defined above, and a complementary base in particular extending along the longitudinal direction, the complementary base having an upper face and a lower face, the lower face being devoid of retaining elements. The complementary base may for example have all or part of the characteristics of the base.

The invention further relates to an absorbent article, for example of the baby diaper or adult incontinence diaper type, which comprises:
an upper sheet, a lower sheet and an absorbent core, arranged between the two upper and lower sheets,
at least one device as defined above.

According to one example, the absorbent article, for example, of the baby diaper or adult incontinence diaper type which comprises at least complementary retaining elements, arranged to cooperate with the retaining elements of the device to close the absorbent article and/or assemble, in particular temporarily assemble, one or more sub-sets of the absorbent article.

### BRIEF DESCRIPTION OF THE DRAWINGS

The invention and its advantages will be better understood upon reading the detailed description given below of different embodiments of the invention given as non-limiting examples.

FIG. 1 shows one example of a device according to one aspect of the invention.

FIG. 2 represents one example of apparatus for producing such a device.

FIG. 3 is a detailed view of FIG. 2.

FIG. 4 shows another example of a device according to one aspect of the invention.

FIG. 5 shows another example of a device according to one aspect of the invention.

FIG. 6 schematically illustrates a cutting step.

FIG. 7 shows another example of a device according to one aspect of the invention.

FIG. 8 shows a detailed view of part of an example of apparatus for the implementation of the invention.

FIG. 9 shows another example of apparatus for the implementation of the invention.

FIG. 10 schematically illustrates one embodiment of a cutting and removal step.

FIG. 11 schematically illustrates another embodiment of a cutting and removal step.

FIG. 12 schematically illustrates another embodiment of a cutting and removal step.

FIG. 13 schematically illustrates one example of device.

FIG. 14 schematically illustrates another example of device.

FIG. 15 schematically illustrates another example of device.

FIG. 16 schematically illustrates another example of device.

FIG. 17 schematically illustrates another example of device.

FIG. 18 shows one example of roller.

FIG. 19 shows another example of device according to one aspect of the invention.

In all of the figures, the elements in common are identified by identical numerical references.

### DESCRIPTION OF THE EMBODIMENTS

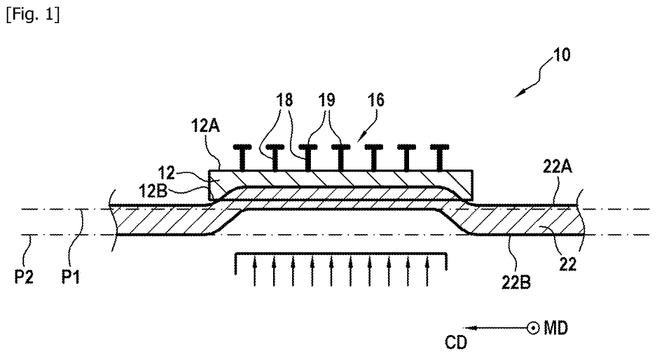

FIG. 1 represents one example of a device according to one aspect of the invention.

FIG. 1 schematically represents a retaining device 10 comprising a base 12 which has an upper face 12A and a lower face 12B and a plurality of retaining elements 16 extending from the upper face 12A of the base 12. By continuous base, it is meant that the base 12 continuously extends along the machine direction MD. In some cases, a continuous base may be devoid of through openings or recesses in the areas not having retaining elements. The base 12 typically has a constant width, the width being measured in the transverse direction CD. As a variant of embodiment, the base 12 could have a variable width or could have, for example, a serrated shape.

Each retaining element 16 comprises a rod 18 and a head 19. The retaining device 10 comprises a support 22 having a lower face 22B and an upper face 22A, the support forming a strip extending along a longitudinal direction. The support 22 is typically a woven or nonwoven material. It is understood that the shape represented for the retaining elements 16 is not limiting. The retaining elements may take the form of hooks, mushrooms, harpoons, or any shape adapted to cooperate with a counterpart to make a hook and loop connection.

The retaining elements 16 typically have a height comprised between 0.7 and 3 mm in some areas, especially between 0.9 mm and 2.5 mm, and in other areas between 0.10 mm and 0.7 mm, especially between 0.15 and 0.45 mm, in particular between 0.2 mm and 0.40 mm, the height being measured along a direction perpendicular to the upper face 12A of the base 12.

The base typically has a density of retaining elements comprised between 50 and 3,000 hooks/cm² , or typically between 100 and 800 hooks/cm² , or between 50 and 450 hooks/cm² , especially between 100 and 400 hooks/cm² , more particularly between 150 and 350 hooks/cm² , in some cases between 230 and 290 hooks/cm².

The base 12 and the retaining elements 16 are typically made of a thermoplastic material, for example a non-elastic thermoplastic material. The base 12 and the retaining elements 16 are made such that they can be stretched under the effect of a stretching force exerted along a given direction and without substantially returning to their initial shape and dimensions after release of this stretching force, in some cases the base breaks under the effect of a stretching force. It is for example a base and the retaining elements which maintain a residual deformation or remanence after elongation and release (residual deformation also called “permanent set” or “SET”) greater than or equal to 20%, preferably greater than or equal to 30%, of its initial dimension (before elongation) for an elongation of 100% of its initial dimension, at room temperature (23° C.—degrees Celsius). In some cases, the base 12 and the retaining elements 16 and/or preform may be formed based on thermoplastic elastomer material and/or based on elastomer. The term “based on” means that the majority material in the given composition, for example at least 30%, or at least 50% of said material.

The base 12 is secured to the support 22. More specifically, the lower face 12B of the base 12 is secured to the upper face 22A of the support 22.

The connection between the base 12 and the support 22 is made by partial encapsulation and/or partial coating and/or partial penetration of the support 22 into the base 12.

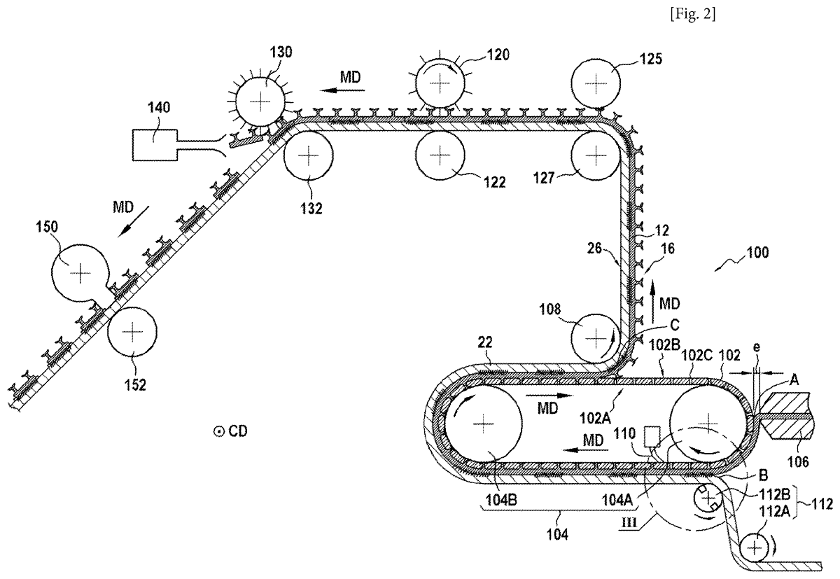

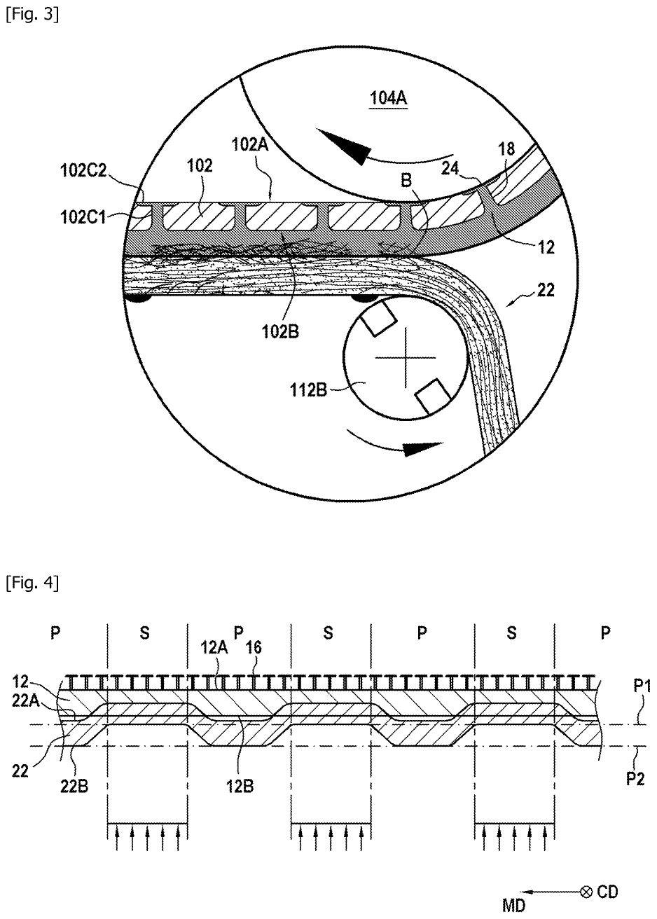

The retaining device 10 can be manufactured for example by means of an apparatus 100 as represented in FIG. 2 and in FIG. 3 which shows a detailed view thereof. The apparatus 100 makes it possible to manufacture a tape 26 for a retaining device, the tape 26 can then be cut out or subdivided into a plurality of retaining devices 10. The tape 26 comprises the base 12 which is here continuous, and a plurality of retaining elements 16. In the embodiment of FIG. 2, the retaining elements 16 are hooks, each hook comprising a rod 18 surmounted by a head 19.

The apparatus 100 as represented comprises a molding strip 102 positioned on rotational drive means 104 here comprising two rollers 104A, 104B, a material distribution means 106, for example an injector, adapted to perform an injection of molding material for example thermoplastic molding material.

The set formed by the molding strip 102 and the rotational drive means 104 thus forms a molding device.

It is meant by machine direction MD the direction of movement of the molding strip 102 in the apparatus 100 during the manufacture of the retaining device in accordance with the acronym for “Machine Direction”, and by transverse direction CD in accordance with the acronym for “Cross Direction” the direction perpendicular to the machine direction MD. These directions are thus identified in the various figures. The machine direction MD corresponds to the longitudinal direction when the retaining device 10 is in the apparatus. The product thus formed defines a strip or a tape extending along the machine direction MD, and typically has a fixed width along the transverse direction CD.

The illustrated example comprising two rollers 104A, 104B is not limiting, the number and the arrangement of the roller(s) 104 may vary in particular in order to adapt to the length of the molding strip 102 and to the different stations of the apparatus. For example, three rollers or even just one roller could be used such that the molding strip is arranged on the periphery of the single roller to form a sleeve or a screen. Especially, only one of the two rollers can be driven in rotation by motorized means, for example the roller 104A, the other roller 104B being free, that is to say without motorized means, and driven in rotation via the molding strip, itself driven by the roller 104A.

The molding strip 102 as presented comprises an inner face 102A and an outer face 102B, the inner face 102A being in contact with the rotational drive means 104.

The material distribution means 106 is disposed so as to inject the molding material onto the outer face 102B of the molding strip 102.

More specifically, the material distribution means 106 is disposed facing the molding strip 102, spaced from the molding strip 102 so as to define an air gap “e” indicated in FIG. 2. Reference A denotes the limit of the material injected onto the outer face 102B of the molding strip 102, corresponding to the rear edge of the material injected onto the molding strip 102 relative to the direction of movement of the molding strip 102.

The molding strip 102 is provided with a plurality of cavities 102C allowing the production of retaining elements or preforms for the production of retaining elements, for example by a subsequent calendering operation or any other suitable operation. Throughout the description, the term retaining elements will be used to designate retaining elements or preforms for the production of retaining elements intended to form a hook and loop fastener of the hook-hook or hook-loop type. In the case of the formation of preforms or precursors for obtaining retaining elements, the apparatus may then comprise a forming device adapted to deform said preforms for obtaining the retaining elements.

The cavities 102C are each typically formed so as to define a rod 102C1 extending from the outer face 102B to the inner face 102A of the molding strip 102 and a head 102C2 extending between the rod 102C1 and the inner face 102A of the molding strip 102.

The molding strip 102 typically has a thickness comprised between 50 and 500 micrometers, or typically between 70 and 350 micrometers.

The molding strip 102 is typically continuous, and typically has a perimeter comprised between 200 mm and 3,000 mm, or typically between 400 mm and 2,000 mm.

The molding strip 102 has a density of cavities 102C comprised between 50 and 3,000 cavities/cm² , or typically between 100 and 800 cavities/cm² or between 50 and 450 cavities/cm² , especially between 100 and 400 cavities/cm² , more particularly between 150 and 350 cavities/cm² , in some cases between 230 and 290 cavities/cm².

It is thus understood that the arrangement of the cavities 102C determines the arrangement of the retaining elements on the retaining device formed using the apparatus 100. The cavities 102C are typically disposed in rows and columns, said rows and columns being arranged respectively along the transverse direction CD and the machine direction MD. Each row and column is composed of one or more cavities 102C, where appropriate aligned along the transverse direction CD and the machine direction MD respectively.

Within a single row, the successive cavities 102C are typically spaced regularly at a transverse interval. Within a single column, the successive cavities 102C are typically spaced regularly at a machine interval. As a variant, said rows are spaced regularly at a first transverse interval and at a second transverse interval, the second transverse interval not being an integer multiple of the first transverse interval and the first transverse interval being smaller than the second transverse interval, and/or said columns are spaced regularly at a first machine interval and at a second machine interval, the second machine interval not being an integer multiple of the first machine interval and the first machine interval being smaller than the second machine interval.

The rows and columns of cavities 102C may be aligned, or disposed in a staggered manner. More specifically, the different cavities 102C can be disposed so as to be aligned along the transverse direction CD and along the machine direction MD, or be offset so as to form a staggered or honeycomb pattern, two successive rows or columns then being offset respectively along the transverse direction and along the machine direction, by a pitch corresponding to half the transverse interval or to half the machine interval respectively.

As will be seen later, it follows that the retaining elements 16 formed using these cavities 102C are disposed in a column and row arrangement, respectively along a primary direction and a secondary direction, typically corresponding to the machine direction MD and to the transverse direction CD.

In the example illustrated, the heads 24 of the cavities 102C open out onto the inner face 102A of the molding strip 102. The cavities 102C are therefore through cavities. Such an embodiment is not limiting, the cavities 102C can also be blind and therefore not open out from the inner face 102A of the molding strip 102 and/or the cavities 102C can only include one rod 102C1.

The portions of the cavities 102C forming the rods 102C1 typically extend along a direction perpendicular to the outer face 102B of the molding strip 102. The portions of the cavities 102C forming the rods 102C1 typically have a rotational geometry about an axis perpendicular to the outer face 102B of the molding strip 102, or a geometry having a plane of symmetry extending along a direction parallel to the direction of travel of the molding strip 102 and/or along a direction perpendicular to the direction of travel of the molding strip 102.

The portions of the cavities 102C forming the heads 102C2 typically extend radially or transversely relative to an axis perpendicular to the outer face 102B of the molding strip 102, and may have a rotational symmetry about this axis perpendicular to the outer face 102B of the molding strip 102. The portions of the cavities 102C forming the heads 102C2 typically have a substantially truncated or hexahedral shape.

The portions of the cavities 102C forming the heads 102C2 may be linear or curved, for example to form curved portions towards the inner face 102A or towards the outer face 102B of the molding strip 102 extending from the portions of the cavities 102C forming the rods 102C1. The molding strip may further have a shape such as those described in patent applications WO0213647 A2 and/or WO0050208 A2.

The portions of the cavities 102C forming the heads 102C2 may have a constant or variable thickness.

In the example represented in the figures, the portions of the cavities 102C forming the heads 102C2 extend radially around the portions of the cavities 102C forming the rods 102C1, and have a general disk shape.

The molding strip 102 may have on its inner face 102A or on its outer face 102B a particular texturing such as slots, a network of grooves or a network of passages forming a vent or pins, or be substantially smooth.

The molding strip 102 may be formed by a superposition of several strips, and is therefore not necessarily a single piece or a single material. The molding strip 102 may be composed of one or more materials or composites, typically metal materials or composites of the Ni, Cu, stainless steel type, or any other suitable material.

The material distribution means 106 is typically disposed so as to perform the injection of molding material into the molding strip 102 in a section of the molding strip 102 where the latter bears against a drive roller, in this case the drive roller 104A in the example represented in FIG. 2. The drive roller then forms a bottom for the cavities 102C.

In the case where the injection of molding material is performed while the molding strip 102 is not bearing against a drive roller, the material distribution means 106 can then comprise a pedestal disposed on the other side of the molding strip 102, so that the inner face 102A of the molding strip 102 is bearing against the base when the injection of material is performed, the pedestal then forming a bottom for the cavities 102C of the molding strip 102.

The injection of material against the molding strip 102 and into the cavities 102C makes it possible to obtain a base 12 having a constant or substantially constant thickness, in particular over at least 30% of the surface of the base 12, or over at least 40%, 50%, 60%, 70% or 80% of the surface of the base. For example, the base 12 has a thickness comprised between 10 and 250 micrometers, in particular between 10 and 120 micrometers, or for example between 25 and 80 micrometers. The injection of material against the molding strip 102 is a continuous material depositing method making it possible to produce a continuous base 12 in the machine direction MD and a successive filling of the molding cavities 102C in the machine direction MD. By constant thickness of the base 12, it is meant a thickness of the base 12 that comprises planar or substantially planar lower and upper faces, or faces that have a particular texturing such as slots, a network of grooves or a network of passages forming a vent or pins, or to be substantially smooth.

By constant thickness, it is meant here that the upper face of the base 12 and the lower face of the base 12 are substantially planar and parallel to each other, with a constant or substantially constant gap whether along the longitudinal direction or along the transverse direction or a constant frequency in a defined axis. The thickness is typically measured in an area outside the alignment of the retaining element.

It is however understood that thickness variations may exist, due to the tolerances of the manufacturing method, and also depending on the removal of the material during its cooling. The notion of constant thickness here qualifies a tape resulting from a continuous deposition of material, as opposed to localized material depositions forming clusters with a decreasing thickness from the center to the ends.

The base 12 thus typically has a constant thickness over at least 30% of its surface, the surface of the base 12 being measured in the plane defined by the machine direction MD and the transverse direction CD. As a variant, the base 12 thus typically has a constant thickness over at least 40%, 50%, 60%, 70%, 80% of its surface.

The use of a molding strip 102 associated with drive means 104 compared to the use of conventional formation means such as rollers in which molding cavities are directly produced is advantageous for several reasons.

The use of a molding strip 102 is in particular interesting in terms of modularity. The molding strip can indeed be easily removed and replaced from the drive means, unlike a solid roller for which the dismouting and remounting operations are particularly complex to perform. Such an advantage is particularly observed when the two rollers 104A, 104B are fixed to a frame on one and the same side, leaving the end of the other side free to introduce/remove the molding strip. A means for guiding the molding strip can also be used to facilitate its introduction and/or removal.

In addition, the production of a molding strip is greatly simplified compared to the production of a roller comprising molding cavities. Such rollers are indeed typically produced by stacking successive slices, therefore requiring multiple machining operations and causing significant constraints during the assembly and at each change of hook reference and have a significant mass requiring these rollers to be held by their two ends, which consequently complicates their replacement.

The cavities 102C in the molding strip 102 may be produced by a chemical etching process or by using a laser at the locations where it is desired to form retaining elements 16. It may also be envisaged to produce the molding strip 102 with cavities 102C distributed uniformly over the entire molding strip 102 and then to plug the cavities 102C at the locations where it is desired to form areas 20 devoid of retaining elements 16, so as to form retaining elements 16 in a uniform or localized manner.

In FIG. 2, reference C identifies the separation between the tape 26 and the molding strip 102, this point corresponding for example to the level from which the base 12 of the tape 26 is no longer in contact with the molding strip 102. It can be provided that the molding strip 102 lifts the demolding roller 108, that is to say the demolding roller 108 forms a lever in the molding strip 102 to facilitate the demolding of the preforms and/or hooks.

In the example represented, the cavities 102C of the molding strip 102 are through cavities. The apparatus may then comprise an element, such as a scraper 110, positioned so as to scrape the inner face 102A of the molding strip 102 to remove excess molding material if necessary. By injection it is meant continuous action of shaping a molding material in a cavity by melting, for example, the distribution, the supply, the molding, the injection, the extrusion.

The apparatus presented and the method associated also present means for and a step of associating a support 22, typically made of nonwoven (or woven) material, with the base 12.

Such an association of a support 22 on a base 12 comprising retaining elements 16 is typically performed by means of an adhesive, or via a fusion of the base or of the strip and/or mechanical anchoring.

In order to perform such a securing of a support 22, for example made of nonwoven material, to the base 12 of the retaining device 10, the apparatus 100 proposed may comprise means for driving the support 22, adapted to perform a strip feed and to apply the support 22 against the lower face 12B of the base 12 downstream of the material distribution means 106, in particular continuously along the longitudinal direction MD and/or along the transverse direction CD.

The apparatus 100 represented in the figures comprises such means.

As seen in the figures, the apparatus as presented comprises support drive means 112, here consisting of two rollers 112A, 112B, configured to perform a support feed 22 downstream of the material distribution means 106.

The support 22 is typically a layer of nonwoven material, a thermoplastic film, an elastic film or a composite film, or a set of thermally consolidated fibers and/or filaments. The support 22 is for example a web of fibers and/or filaments.

In the example represented in the figures, the support 22 is represented as being a layer of nonwoven material.

The substrate drive means 112 are configured to feed the apparatus with the support 22, and to apply this support 22 against the lower face 12B of the base 12 downstream of the material distribution means 106, and downstream of the formation of the base 12 by application of the material against the molding strip 102 and in the cavities 102C.

The substrate drive means 112 are configured so that this application is performed prior to the solidification of the base 12. Thus, this application causes at least partial penetration of the support 22 beyond a plane defined by the lower face 12B of the base 12. The point of contact between the base 12 and the support 22 is identified by the reference B in the figures.

More specifically, the lower face 12B of the base 12 is substantially planar, and defines a plane. The application of the substrate against this face causes penetration of portions of the support 22, for example fibers and/or filaments of the layer of nonwoven material in the case where the support 22 is a layer of nonwoven material within the base 12, thereby passing through the lower face 12B of the base 12. According to one embodiment, the base 12 could be reheated by applying a hot fluid on the lower surface of the base 12 and/or on the upper surface of the support 22 or substrate to allow the base 12 and the support 22 to be fixed, for example as described in document WO2011087752 A2 incorporated by reference to the description and to the content of which reference may be made.

Throughout the description, it is understood that “substrate” or “support” have the same meaning and are equivalent such that they can be interchanged with each other.

To the extent that such an application is performed prior to the solidification of the base 12, it is not necessary to heat the base 12 and/or the support 22 in order to make such a connection.

As an example, considering a base 12 made of polypropylene, the application of the substrate against the lower face 12B of the base 12 is typically performed when the lower face 12B of the base 12 has a temperature comprised between the melting temperature of the material and the Vicat softening temperature B of the material constituting it minus 30° C. (degrees Celsius) or between the melting temperature of the material constituting it and the Vicat softening temperature A of the material constituting it. More particularly, when the base comprises a polypropylene-based material, the lower face 12B of the base 12 has a temperature comprised between 75° C. and 150° C., typically of the order of 105° C., this temperature being typically measured by means of an infrared or laser camera. It is meant by VICAT softening temperature the temperature obtained according to one of the methods described in the ISO 306 or ASTM D1525 standards with a heating rate of 50° C./h and a standardized load of 50N for the VICAT B and a standardized load of 10N for the VICAT A. Other types of materials than Polypropylene (PP) could be used, for example, another thermoplastic material such as Polyethylene (PE), a PE-PP copolymer, a polyamide (PA), a thermoplastic elastomer, a polyester, a polylactic acid (PLA), a Polybutylene adipate terephthalate (PBAT), these materials being able to be used independently or in combination.

In the case where the support 22 is a set of thermally consolidated fibers and/or filaments, the connection with the base 12 is also made by penetration into the base 12 of part of the fibers and/or filaments of the support 22.

In the case where the support 22 is a set of consolidated fibers and/or filaments for example thermally consolidated fibers and/or filaments, a thermoplastic film, an elastic film or a composite film, the connection with the base may then result in a shrinkage phenomenon of the base 12 during its cooling, this shrinkage promoting the connection surface between the substrate and the base of the tape. This shrinkage has no impact on the visual appearance for the end user.

The application of the support 22 on the base 12 is typically performed in such a way that, in the area of the application of the support 22 on the base 12, the length of an extension of the base 12 and the length of an extension of the support 22 have a difference of less than 10%, in particular a continuous contact along the longitudinal direction MD and/or along the transverse direction CD is made between all or part of the lower surface of the base 12 and the support 22. The extension designates the projection onto a plane of an element considered, in this case the base 12 and the support 22 on a plane typically parallel to the internal face of the base 12.

In the case where the support 22 is a layer of nonwoven material, the demolding of the retaining elements is performed easily even with a nonwoven material whose grammage is less than 80 g/m² (mass of material in grams per square meter of nonwoven material). For example, the grammage of the nonwoven material can be comprised between 5 g/m² and 120 g/m² , or between 25 g/m² and 100 g/m² , or between 10 g/m² and 70 g/m² , in some cases between 10 g/m² and 50 g/m².

The set formed by the base 12, the retaining elements 16 and the support 22 of the retaining device may have a grammage comprised between 30 and 150 g/m², especially between 40 and 120 g/m² of support, more particularly between 45 and 100 g/m² of support, the grammage value being indicated here relative to the surface of the support 22.

In the case where the support 22 is a layer of nonwoven material, the apparatus may comprise a calendering device upstream of the substrate drive means 112 thus making it possible to perform a step of calendaring, locally or not, the layer of nonwoven material prior to its application against the base 12.

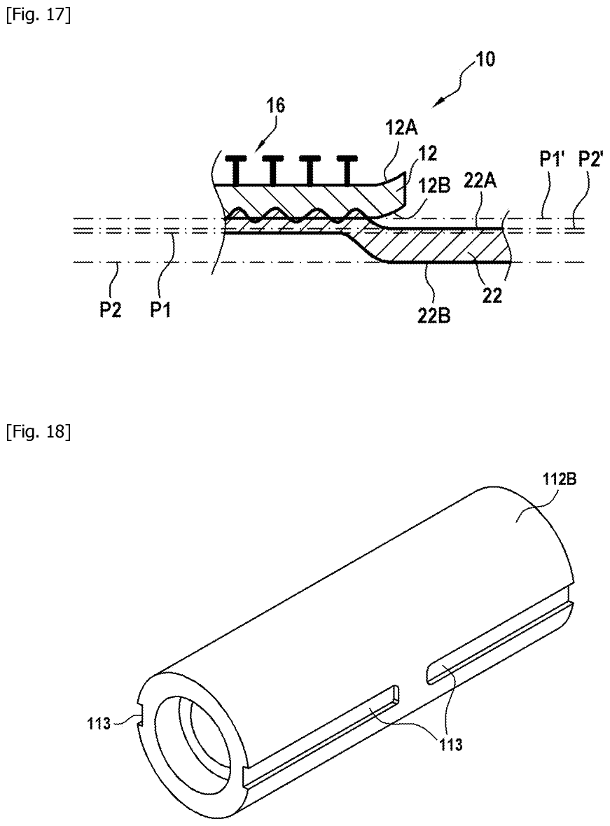

The support 22 can thus be calendered per area prior to its application on the base 12, the calendered areas of the support 22 having a thickness at least 10%, preferably at least 30%, smaller than the non-calendered areas and a surface greater than 5 mm², in particular at least 15 mm². During the application of the support 22 against the base 12, these areas of distinct thickness will then determine areas of greater thickness pressurized on the base 12 which are secured to the base 12, and calendered areas of smaller thickness which are not secured to the base 12. According to one example, as represented for example in FIG. 17, an upper face of the non-calendered areas of the support 22 extends along an non-calendered plane P1′ and an upper face of the calendered areas of the support 22 extends along a calendered plane P2′ distinct from the non-calendered plane P1′, the non-calendered areas of the support 22 being intended to be secured to the base 12 and the calendered areas of the support 22 being intended not to be secured to the base 12. In the example illustrated in FIG. 17, the upper face of the calendered areas of the support 22 extending along a calendered plane P2′ extends in or substantially in the first plane P1 corresponding to the upper face 22A of the substrate 22. As a variant of embodiment, the upper face of the calendered areas of the support extending along a calendered plane P2′ may extend further from the base 22 than the first plane P1 corresponding to the lower face 22B of the substrate 22 or vice versa.

This mode of securing a support 22 to a base 12 comprising retaining elements 16 is in particular advantageous in that it does not cause deformation of the base 12, and therefore advantageously makes it possible to maintain the shape of the base 12 obtained during the injection step, and in particular to maintain the straight edges that can be obtained via the method and the apparatus described above straight.

This mode of securing a substrate to a tape can be applied to a method for forming a tape as described above, or more generally to any other method for forming a tape comprising retaining elements such as hooks.

The application of the support 22 on the base 12 is here performed in a non-uniform manner, so as to define portions of the base 12 secured to the support 22, and portions of the base 12 not secured to the support 22.

By portion of the base 12 secured or not secured to the support 22 is meant a portion of the base 12 delimited by a contour on its upper face 12A for which the lower face 12B of the base 12 is secured or not secured to the support 22, regardless of the securing means used. In other words, a non-secured portion may for example correspond to a portion for which a recess exists between the base 12 and the support 22 and/or for which the support 22 and the base 12 can be deformed independently of each other.

The non-uniform application of the support 22 on the base 12 is performed for example by means of the roller 112B which has an irregular surface, for example provided with patterns, thus defining protrusions and hollows on the surface of the roller 112B. It is understood that the protrusions will apply a force tending to secure the support 22 to the base 12, while the hollows will not apply a force allowing such a securing. For the purposes of illustration, the roller 112B is represented as having two notches defining hollow areas.

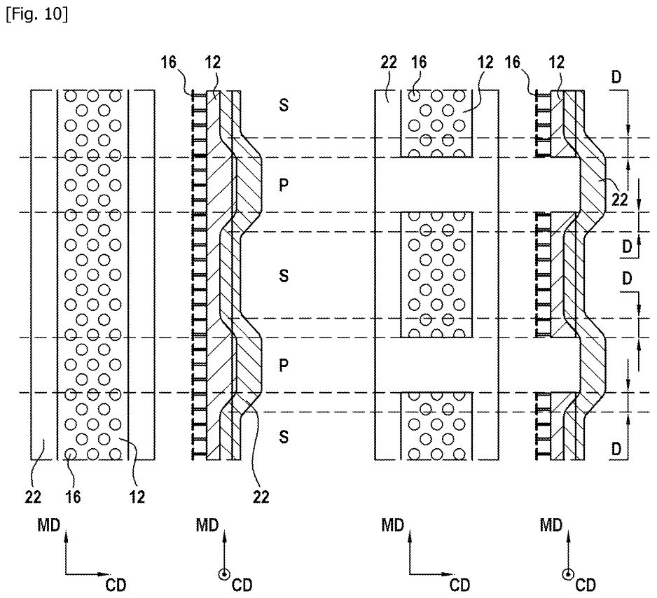

FIG. 18 shows one example of such a roller 112B. In the illustrated example, the roller comprises two pairs of grooves 113 formed on the outer surface of the roller 112B, the two pairs of grooves being offset by 180°. It can be seen that each groove extends from a lateral end of the roller 112B over less than half of the roller along the transverse direction CD. The grooves 113 of each pair of grooves are disposed opposite each other. Thus, a regular or planar central portion is maintained between the grooves 113 of each pair of grooves. Such a configuration makes it possible to obtain a discontinuous securing along the machine direction MD as for example illustrated in FIG. 10, or to obtain a continuous securing along the machine direction MD as for example illustrated in FIG. 12.

This therefore results in an irregular penetration of the support 22 in the base 12. The resulting irregular appearance of the lower face 22B of the support 22 is schematically represented in the different views. More specifically, it is understood that the relief areas of the roller 112B cause the substrate 22 to penetrate or not to penetrate into the base 12. Thus, it can be seen in the various figures, in particular FIGS. 1, 4 and 5, that the substrate 22 penetrates into the base 12 in the areas of application of a force by the roller 112B, but does not penetrate into the base 12 in the areas of non-application of a force by the roller 112B.

The various figures schematically represent the irregular appearance of the substrate 22, for which two planes defining its lower face 22B can generally be defined:
a first plane P1 corresponding to the lower face 22B of the substrate 22 at the areas of application of a force by the roller 112B, and
a second plane P2 corresponding to the lower face 22B of the substrate 22 at the areas of non-application of a force by the roller 112B, the second plane P2 being distinct from the first plane P1, and typically parallel or substantially parallel to the first plane P1.

The roller 112B may be made of a material such as stainless steel, rubber, polyurethane, composite or a combination of several materials, in particular a combination of several of these materials. The roller 112B may also comprise one or more bushings or envelopes bearing the laminating pattern according to the invention allowing them to be quickly and easily dismounted depending on the pressure areas to be applied. As a variant of embodiment, in the case where the substrate 22 is calendered beforehand, the roller 112B may be smooth. Complementarily or alternatively, the external surface of the roller 112B may have a hardness less than or equal to 100 shore A, especially less than or equal to 90 shore A and/or greater than 40 Shore A, in particular greater than or equal to 60 Shore A, measured according to the ISO 48-4:201 8 or ISO 868:2003 method.

It is thus possible to define a first set of areas in which the substrate 22 is secured to the base 12, and a second set of areas in which the substrate 22 is not secured to the base 12, the first set of areas extending in the first plane P1, and the second set of areas extending in the second plane P2. The second set of areas may in particular include areas not comprising or no longer comprising the base 12.

In other words, in the areas of application of a force by the roller 112B, the substrate 22 penetrates at least partially into the base 12. Thus, the thickness of the substrate 22 extending outside the base 12 is reduced. Due to the application of a compressive force by the roller 112B, the total thickness of the substrate 22 (that is to say the cumulative thickness of the substrate extending outside the base 12 and having penetrated into the base 12) in the areas of application of a force by the roller 112B is reduced relative to the initial thickness of the substrate 22. By initial thickness of the substrate 22 is meant the thickness of the substrate upstream of the roller 112B. Conversely, in the areas of non-application of a force by the roller 112B, the substrate 22 does not penetrate into the base 12. The thickness of the substrate extending outside the base 12 then typically corresponds to the initial thickness or substantially to the initial thickness of the substrate 22.

According to one example, the distance between the first plane P1 and the second plane P2 is typically greater than 10 micrometers.

According to one example, the ratio of the distance between the first plane P1 and the second plane P2 to the thickness of the base 12 is typically comprised between 0.01 mm and 3 mm, especially between 0.01 mm and 1 mm, in other cases between 1 mm and 3 mm, in particular between 1 mm and 2.5 mm.

It is understood that the representation of the variations of the substrate is schematic and not limiting. The upper face 22A of the substrate 22 is in particular represented as being at a distance from the base 12 for the purposes of illustration and readability of the figures, but it is understood that it can be bearing against the lower face 12B of the base 12, or in the same plane.

In contrast, in the case of a uniform application of the support 22 against the base 12, a substantially planar lower face 22B of the substrate 22 would be observed.

This results in a device comprising a support 22 and a base 12 as defined above, and for which the base 12 has a plurality of segments secured to the support 22, these segments being connected to each other by connecting portions not secured to the support 22.

Such a non-uniform application of the support against the base is unconventional and counter-intuitive. Advantageously, to obtain devices according to the invention using rollers rotating at high speed to apply a pressure, it is preferable to ensure continuous contact between these rollers to avoid jolts at each transition between a bearing area and a non-bearing area and thus avoid damaging these rollers. This continuous contact can be made in one (or more) area(s) in which the application of the support 22 on the base 12 is performed and/or outside one (or more) area(s) in which the application of the support 22 on the base 12 is performed. For example, the roller 112B having solid portions adapted to apply a force tending to secure the support 22 to the base 12, and hollowed-out areas, configured so as not to apply a force tending to secure the support 22 to the base 12, comprises a maximum external perimeter, and all straight lines extending along the direction CD and passing through the maximum external perimeter intersect at least one point of the roller 112B. Thus, such a roller 112B is devoid of a surface cavity extending continuously over the entire width of the roller 112B along a straight line perpendicular to the machine direction MD. The continuous contact is thus not made in an area where there is the base 12 but in an area where there is no support 22. As a variant, to improve the performance of the non-contact area, it is also possible to perform suction from this cavity of the roller 112B to limit the contact of the support 22 on the base 12 by tending to space the support 22 away from the base 12. Such continuous contact could also be duplicated to systems other than rollers 112B, for example for ultrasonic welding modules.

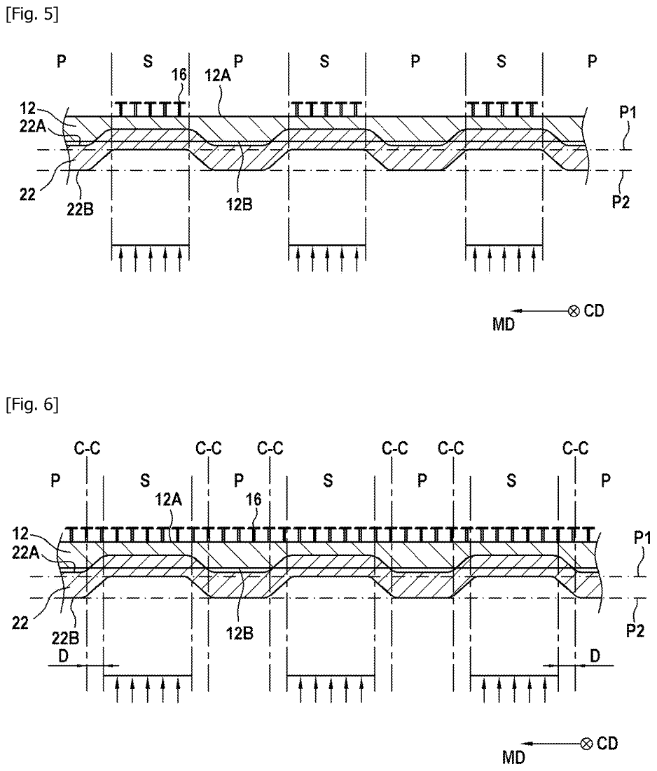

FIGS. 4 and 5 represent two examples of such devices.

These figures schematize the connection between the base 12 and the support 22 by a penetration of the support 22 into the base 12, which symbolizes an encapsulation area of the support 22 in the base 12 to ensure the connection between the base 12 and the support 22.

These figures also schematize the application of a force by the roller 112B by means of arrows. It can be seen here that the application is non-uniform over the entire base 12, and that the connection between the base 12 and the support 22 is only made facing the areas of application of force by the roller 112B. The areas of non-application of force correspond for example to the notches in the roller 112B mentioned above.

As indicated above, this results in a non-homogenous penetration of the substrate 22 into the base 12; the internal face 22B of the substrate 22 is thus essentially comprised in the distinct first plane P1 and second plane P2.

These figures identify an alternation of segments S and connecting portions P, disposed successively along the longitudinal direction MD.

The connecting portions P may be provided with retaining elements 16 or devoid of them, as represented respectively in FIGS. 4 and 5, depending on the configuration of the molding strip 102.

The shape and location of the connecting portions P may be freely defined via the means performing the application of the support 22 on the base 12, whether by means of an adhesive, by welding or by partial penetration of the support 22 into the base 12.

This non-uniform securing of the base 12 on the support 22, or of the support 22 on the base 12, causes a discontinuity in the appearance of the support 22, in particular in the case where the support 22 is a nonwoven material. The discontinuity in the appearance of the support 22, in particular a visually discernible discontinuity in the appearance of the support 22, is materialized by a difference in weight of the support 22 and/or in surface density of the fibers and/or filaments, and/or in thickness.

“Visually discernible” means visible and visually detectable at a distance of about 0.5 meters or more, to the naked eye of an ordinary observer having 20/20 vision, under indoor office lighting conditions deemed suitable for reading printed textual supports.

Indeed, due to the partial securing of the base 12 on the support 22, a discontinuity in the appearance of the support 22 between the areas secured to the base 12 and the areas not secured to the base 12 is observed in particular from the lower face 22B of the support 22. Indeed, as described above, the non-uniform application of the substrate 22 against the base 12 results in non-uniform penetration of the substrate 22 into the base 12. Thus, unlike the conventional methods which result in a uniform appearance, the proposed method makes it possible to obtain products in which the substrate 22 has a non-planar lower face 22B, or more generally extending essentially in two distinct planes corresponding to the areas of application or non-application of a force aimed at securing the substrate 22 in the base 12.

After the formation of such a device, the connecting portions P can be removed, for example during an ablation or trimming step.

The apparatus presented in FIG. 2 illustrates one particular embodiment for performing such steps. As a variant, these steps can be performed subsequently. The intermediate product obtained is then packaged in reels or rollers, and the connecting portions P will then be removed during a subsequent step.

At the end of the demolding by the demolding roller 108, a cutting device 120 is positioned, adapted to make cutouts of the base 12, between each segment and each connecting portion.

In the example illustrated, the cutting device 120 is a roller provided for example with blades, associated with a second roller 122 forming a cutting support. It is understood that this example is not limiting, and that any suitable cutting device can be used.

The effect of the cutting is schematically represented in FIG. 6. In this figure, the cutouts are identified by dotted lines identified by the C-C axis.

As can be seen in this figure, the cutouts are typically made so that all or part of the connecting portions P are separated from the segments S. On the other hand, the cutouts are typically made so as not to encompass part of the segments S. In other words, the cutouts are made so as not to cross the connecting areas between the base 12 and the support 22 which are here symbolized by the penetration areas of the support 22 in the base 12. Thus, a non-zero gap D exists between the periphery of the penetration areas of the support 22 in the base 12 and the cutouts. In other words, if the force application areas for securing the support 22 to the base 12 are represented, a non-zero gap D exists between the periphery of the force application areas and the cutouts.

The portions thus cut out are therefore devoid of areas in which the base 12 is secured to the support 22, which in particular makes it possible to avoid tearing or degradation of the support 22 during the removal of the cut parts.

The product obtained thus comprises a support 22 on which different retaining areas are secured, each retaining area comprising a base provided with retaining elements. Due to the non-zero gap D between the periphery of the force application areas and the cutouts, it is understood that each retaining area has on all or part of its periphery a border of dimension D which is not secured to the support 22. This border may for example extend over a distance of less than 3 mm, especially less than 2 mm, less than 1 mm or less than 0.5 mm from the outer periphery of each retaining area.

The proposed device may have a reference means or element for the cutting, for example a marking, a hole, an embossing or an ink layer, which may for example be formed on the upper face 12A of the base 12, so as to form a visual marker to guide the cutting operation or to allow simplified verification of the cutouts made.

The apparatus presented then comprises a removal device 130 associated with a roller 122 forming a removal support and with a suction device 140 disposed downstream of the cutting device 120. These two devices are adapted to perform a removal of the connecting portions and their recovery by suction. The removal device 130 is for example a roller provided with brushes or gripping elements, making it possible to isolate the gripping portions, these then being sucked up by the suction device 140 typically to be recycled. As a variant, the removal device 130 and/or the suction device 140 could be a system for in-line cleaning by rollers with or without contact. As a variant of embodiment, the removal device 130 and/or the suction device 140 could comprise a module with rotating blades or a cylinder with cutting plates or the like or with a guillotine type, more particularly kiss cutting type module.

Thus, when the product passes through the removal device 130 and the suction device 140, the cut portions are separated from the support 22, and are sucked up to be discharged from the apparatus. The material thus sucked up can for example then be recycled and then reinjected by the material distribution means 106.

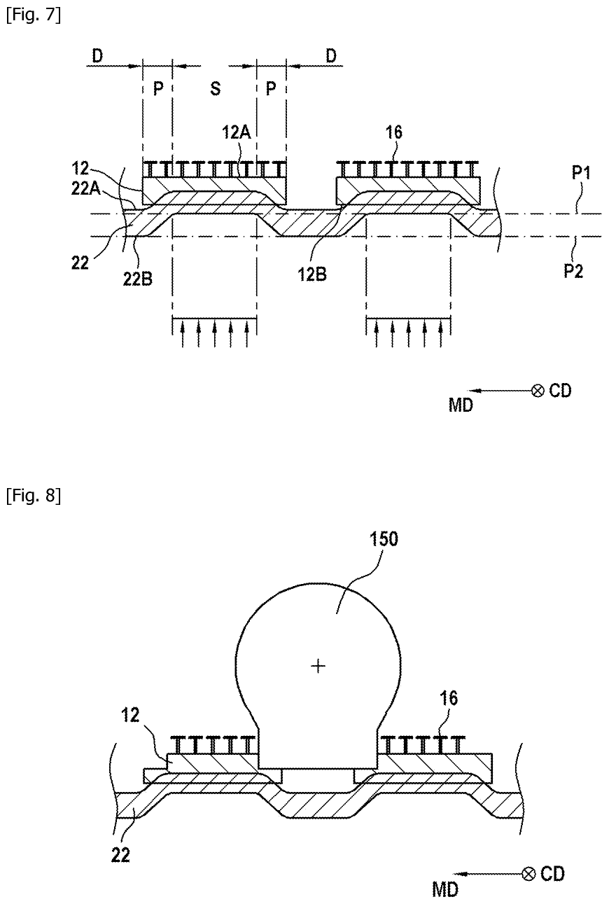

At the end of the removal device, a device is thus obtained comprising a support 22 and a plurality of disjoint segments secured to the support 22. These different base segments typically have a constant or substantially constant thickness, as opposed to areas of retaining elements that would be formed by localized depositions of material directly on the support 22 that would have a non-uniform thickness, and in particular that would decrease towards the edges of said areas. FIG. 7 thus presents one example of the obtained device. Due to the non-zero gap D, it can be observed that the outer periphery of the different segments is not secured directly to the support 22, whether by welding, addition of an adhesive or by partial encapsulation of the support 22 in the base 12. According to one example, D is greater than 0 mm and less than 3 mm, especially less than 2 mm, more particularly especially less than 1 mm, and in particular especially less than 0.5 mm.

It can be seen in particular in FIG. 7 that the removal of part of the base 12 not secured to the support 22 maintains the irregular structure of the lower face 22B of the support 22, and in particular the different areas extending in two distinct planes P1 and P2.

Optionally, the apparatus may also comprise a consolidation device 150 associated with a roller 152, the consolidation device being adapted to calender all or part of the periphery of the segments. In the example illustrated, the consolidation device 150 takes the form of a roller adapted to calender all or part of the contour of the upper face 12A of the base 12. As a variant of embodiment, the consolidation device 150 could be a hot calendering module or an ultrasonic welding module, for example an ultrasonic welding module with a rotating head.

In one variant, the consolidation can be made simultaneously with the cutting step, according to one example, the cutout can be made by an ultrasonic system, advantageously making it possible to simultaneously weld the cut edge.

By way of example, at least 10%, especially 15%, 20%, 25%, 30%, 35% or 45% of the periphery of the segments can be calendered and/or secured to the support 22.

According to one example, the periphery portion forming an outer periphery of the base 12 extends over a maximum distance of 3 mm, especially 2 mm, especially 1 mm, especially 0.5 mm from the outer periphery of the base segment considered. The periphery portion may comprise or not comprise retaining elements.

According to one example, at least 50%, especially 55%, 60%, 65%, 70%, 75%, 80%, 85%, 90%, 95% or 100% of the surface of the periphery portion is not secured to the support. According to one example, at least 50%, especially 55%, 60%, 65%, 70%, 75%, 80%, 85%, 90% or 95% of the surface of the periphery portion is secured to the support 22. As a variant, 100% of the surface of the periphery portion is secured to the support 22. According to one example, all or part of the periphery portion secured to the support 22 has a thickness smaller than the thickness of an internal portion of the base segment considered. The surface of the periphery portion secured to the support 22 may have a decreasing shape whose decrease is oriented towards the outside of the base 12, for example the base 12 has the general shape of a bevel.

FIG. 8 shows a detailed view of the example illustrated in FIG. 2.

As can be seen in this figure, the consolidation device 150 is here configured so as to calender an upstream end of a segment and the downstream end of another segment. The consolidation device, if necessary, crushes the retaining elements 16 present on the periphery of the segments, and performs a calendering operation and thus reduces the thickness of the base 12 over all or part of the periphery of each segment.

The calendering operation is typically performed on all or part of a periphery of each segment, typically including all or part of a periphery of each segment not secured to the base 12, and may also include all or part of a periphery of each segment secured to the base 12.

As an example, the thickness of the base 12 may then be reduced by a minimum of 10, 20, 30 or 40%, and by a maximum of 50, 60, 70 or 80%. It is thus understood that the reduced thickness of all or part of the periphery of the base, or of each segment of the base, typically results from the calendering operation, and not from the formation of the base by injection of material.

The consolidation device 150 and the calendering it performs typically make it possible to secure or confirm or reinforce the securing of the support 22 to the base 12.

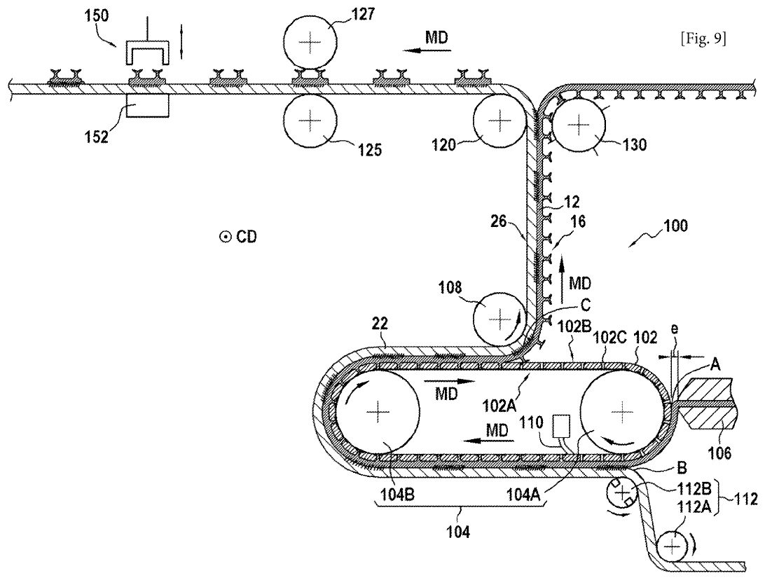

FIG. 9 shows another embodiment of the apparatus described above.

In this embodiment, the material cutting and removal operations are performed simultaneously. The cutting device 120 and the removal device 130 are here represented as being two rollers disposed on either side of the product after demolding.

Such an embodiment is in particular advantageous when the material to be removed forms a continuous material skeleton and in particular easy to roll up.

This embodiment optionally represents a perform calendering device 125 which comprises a preform calendering roller 125 associated with a second roller 127 forming a calendering support to form retaining elements. It is understood that this example is not limiting, and that any suitable preform calendering device can be used, especially, the preform calendering device 125 could be arranged before or after the consolidation device 150 and/or before or after the removal device 130 and/or before or after the cutting device 120.

In this embodiment, the consolidation device 150 takes the form of a device comprising a hammer and anvil system designated respectively by the references 150 and 152. It is understood that this embodiment is not limiting, and that the consolidation device can take any suitable form for crushing or calendering all or part of the periphery of the segments, for example a cam movable in translation.

As a variant of embodiment, the consolidation device 150 may be a hot calendering module or an ultrasonic welding module, for example an ultrasonic welding module with a rotary head. In one variant, the cutout can be made simultaneously with the cutting step; according to one example, the cutout can be made by an ultrasonic system, advantageously making it possible to simultaneously weld the cut edge.

FIG. 10 schematically represents one example of a device obtained at different stages.

By way of example, the retaining device has a ratio of the distance S to the distance P, along the longitudinal direction MD, which is greater than 1, in particular greater than 1.5, especially greater than 5, especially greater than 10 and/or less than 2,000, in particular less than 1,000, more particularly less than 500, in particular less than 200, in particular less than 100, or which is greater than or equal to 0, in particular greater than 0.1, especially greater than 0.2 and/or less than or equal to 1, in particular less than 0.9, more particularly less than 0.8.

As an example, alternatively or in combination in particular with the ratio values mentioned in the paragraph above, the retaining device has a ratio of the distance S to the distance P, along the transverse direction CD, which is greater than 1, in particular greater than 1.5, especially greater than 5, especially greater than 10 and/or less than 2,000, in particular less than 1,000, more particularly less than 500, in particular less than 200, in particular less than 100, or which is greater than or equal to 0, in particular greater than 0.1, especially greater than 0.2 and/or less than or equal to 1, in particular less than 0.9, more particularly less than 0.8.

This figure represents a device comprising the support 22 on which the base 12 is formed continuously. As already described above, the base 12 is partially secured to the support 22. The connecting segments S are here cut out and removed via cutouts made along the transverse direction CD. A product comprising the support 22 and a plurality of disjoint segments secured to the support 22 is thus obtained, these segments here maintaining their initial width insofar as in this example, only cutouts along the transverse direction CD are made.

The base 12 typically has a width (measured along the transverse direction CD) strictly smaller than the width of the support 22. The base 12 is thus disposed on the support 22 such that the support 22 has areas devoid of a base on either side of the base 12 along the transverse direction CD. According to one example, the periphery of the base 12 is at any point at least 3 mm distant from the periphery of the support 22.

In such an embodiment in which base portions are cut out along the transverse direction CD, the total dimension of the base along the longitudinal direction MD, or the sum of the different base portions along the longitudinal direction MD is strictly smaller than the dimension of the support 22 along the longitudinal direction MD.

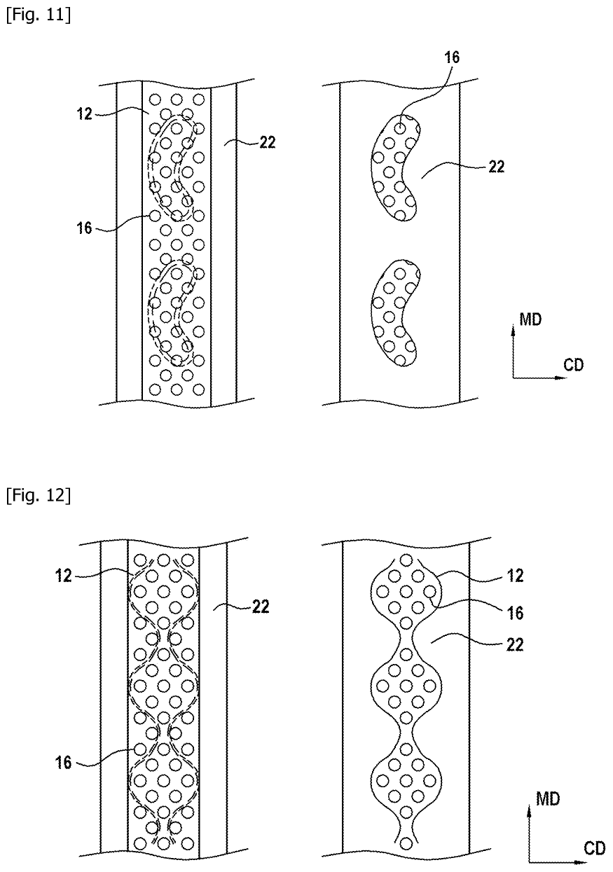

FIG. 11 shows another example of a device obtained at different stages.

This figure represents a device comprising the support 22 on which the base 12 is formed continuously. The support 22 is here secured to the base 12 so as to define geometric shapes, here having the shape of a ring or bean or peanut portion or any other shapes with retaining elements such as for example those described in documents WO2019145646 A1, WO2021116612 A1, WO2021116613 A1. The areas secured to the support 22 which thus correspond to the segments are identified by dotted lines.

The segments S of the base 12 are therefore here surrounded by connecting portions not secured to the support 22. The cutouts are made around each segment, and are represented by dotted lines surrounding each segment. The material removed from the strip here forms a continuous tape with recesses corresponding to the segments S.

According to another variant, the base 12 may have a single continuous segment extending along the longitudinal direction MD. The cutouts are then made on either side of this segment along the transverse direction CD. FIG. 12 schematically represents such a variant. In this embodiment, it can be seen that the cutouts have been made on either side of a continuous strip of material extending along the longitudinal direction MD.

More generally, in the products obtained, if it is considered that the base 12 obtained at the end of the cutting step is delimited by two parallel straight lines extending along the longitudinal direction MD, the base 12 has an occupancy rate of the area delimited between these two parallel straight lines strictly less than 100%, or for example less than 95% or less than 80%, typically greater than 5%, for example greater than 15%, greater than 35% or greater than 55%.

In the embodiments represented in FIGS. 10, 11 and 12, the base 12 has retaining elements 16 formed in a uniform or substantially uniform manner on its upper face 12A. It is understood that these examples are not limiting, and that the retaining elements 16 may be formed on part of the upper face 12A of the base 12, for example only on the parts of the upper face 12A corresponding to the segments S, that is to say the parts of the base that are secured to the support 22.

The segments obtained may form different patterns, depending on the desired technical and visual effect.

The strips thus obtained may then be cut out to obtain retaining devices in order to be integrated into different products or articles.

The products obtained are typically associated with a complementary device comprising a complementary base provided with complementary elements adapted to cooperate with the retaining elements to form a hook and loop connection. The complementary device may then have or not have properties and a structure similar or identical to the device as described.

The invention as proposed thus makes it possible to produce retaining devices comprising a support 22 on which segments provided with retaining elements secured to the support 22 are disposed. These segments have a constant thickness, where appropriate with the exception of all or part of the periphery which is calendered in order to improve their mechanical strength. The segments obtained are thus more regular and have better homogeneity compared to products obtained by localized depositions of material on the support. In addition, the proposed invention makes it possible to form a device provided with different segments spaced from each other along the longitudinal direction MD, which is complex to achieve by the conventional methods that generally propose a differentiation along the transverse direction CD via co-extrusion methods that are not suitable for such a formation of disjoint segments along the longitudinal direction MD. Indeed, the conventional methods that generally propose a differentiation along the transverse direction CD only require a change in the shape of the die, which is not the case for a device provided with different segments spaced from each other along the longitudinal direction MD.

The method used makes it possible to preserve the support 22 by avoiding tearing or degradation of the support 22 during the removal of portions of the base 12 while reducing and limiting the amount of material used to produce the base and the retaining elements to the desired function. In other words, it is possible to obtain a product that does not comprise an oversized base due to the constraints related to the method for manufacturing the base and/or the retaining elements.

The manufacturing method used also allows a recycling of the material of the base 12 removed during the method. The offcuts can therefore be recycled and reinjected into the method, in particular for the formation of the base 12. For example, depending on the shape of the cut portions, the material injected for the formation of the base can contain between 1 and 80% of recycled material, or between 10 and 50% of recycled material.

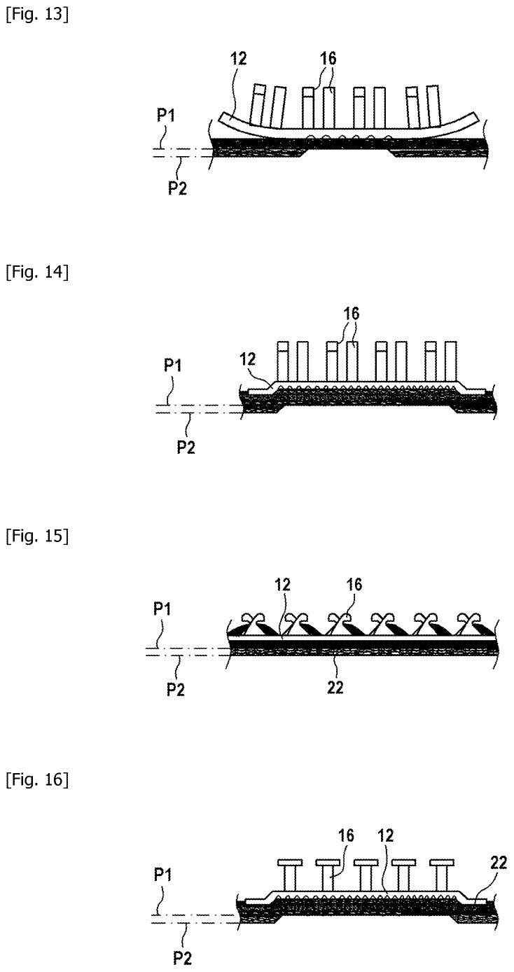

FIGS. 13, 14, 15 and 16 show different examples of retaining elements that can be used.

In the example represented in FIGS. 13, 14 and 15, the retaining elements are hooks having a body with a generally triangular shape, and a head extending from the top of the body towards one side, so as to form a retaining portion. Such types of retaining elements are typically arranged in pairs with heads extending in two opposite directions.

The example represented in FIG. 16 has retaining elements each comprising a rod, and a head formed by a disk extending from the free end of the rod, the disk extending radially around the rod so as to form hooking portions. It is understood that a head can take the form of a disk, or more generally any shape adapted so as to form fins extending around the free end of the rod.

The example represented in FIG. 17 is a variant of FIG. 13, in which the retaining elements are of the type described with reference to FIG. 16.

Optionally, the device can comprise several distinct base portions.

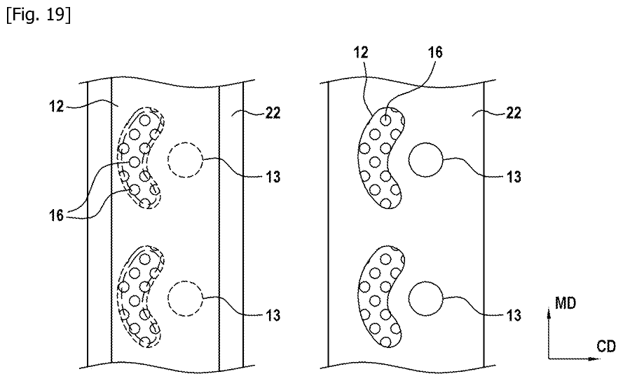

FIG. 19 shows one variant illustrating such an embodiment. This figure shows a variant of FIG. 11; it shows the base 12 provided with retaining elements 16. In this embodiment, the portions of the base 12 not secured to the support 22 are not provided with retaining elements. In this embodiment, it is seen that a portion of the support 22 is secured to part of the base devoid of retaining elements. After removal of the portions of the base not secured to the support 22, a device 10 comprising a base 12 provided with retaining elements 16 as already described previously, and also a complementary base 13 devoid of retaining elements disjoint from the base 12 and secured to the support 22, are thus obtained. Such an embodiment makes it possible in particular to define gripping areas.

The device as presented can in particular be used within the framework of an absorbent article, for example of the baby diaper or adult incontinence diaper type, which comprises:
an upper sheet, a lower sheet and an absorbent core, arranged between the two upper and lower sheets,
at least one device as proposed,
at least complementary retaining elements, arranged to cooperate with the retaining elements of the device to close the absorbent article and/or to assemble, in particular temporarily assemble, one or more sub-sets of the absorbent article.

Although the present invention has been described with reference to specific exemplary embodiments, it is obvious that modifications and changes can be made to these examples without departing from the general scope of the invention as defined by the claims. Especially, individual characteristics of the different embodiments illustrated/mentioned can be combined in additional embodiments. Consequently, the description and drawings should be considered in an illustrative rather than restrictive sense.

The sum of the percentages of the surface of the periphery portion secured to the support 22 and of the surface of the periphery portion not secured to the support 22 is equal to 100%.

In some cases, the retaining device comprises a ratio of the surface S to the surface P which is greater than 1, in particular greater than 1.5, especially greater than 5 and/or less than 2,000, in particular less than 1,000, more particularly less than 500.

In other cases, the retaining device comprises a ratio of the surface S to the surface P which is greater than or equal to 0, in particular greater than 0.1, especially greater than 0.2 and/or less than or equal to 1, in particular less than 0.9, more particularly less than 0.8.

Especially, as a variant of embodiment, in particular for all of the embodiments described and/or in combination of embodiments described, the cutting operation, the material removal operation and the operation of securing to the support 22 are performed simultaneously, for example with an ultrasonic welding module, for example an ultrasonic welding module with a rotary head.

Especially, as a variant of embodiment, in particular for all of the embodiments described and/or in combination of embodiments described, the cutting operation and the operation of securing the base 12 to the support 22 are performed simultaneously, for example with an ultrasonic welding module, for example an ultrasonic welding module with a rotating head.

Especially, as a variant of embodiment, in particular for all of the embodiments described and/or in combination of embodiments described, the preform calendering device 125 could be arranged before or after the consolidation device 150 and/or before or after the removal device 130 and/or before or after the cutting device 120.

It is also obvious that all of the characteristics described with reference to one method are transposable, alone or in combination, to one device, and conversely, all of the characteristics described with reference to one device are transposable, alone or in combination, to one method.

1. A method for manufacturing a retaining device, wherein:
a continuous base is formed, the base extending along a longitudinal direction, the base having a lower face and an upper face, the upper face of the base comprising a plurality of retaining elements and/or preforms for the formation of retaining elements, the base having a constant thickness between its lower face and its upper face, in particular over at least 30% of the surface of the base,
a support having a lower face and an upper face is provided, the support extending along the longitudinal direction, in particular extending continuously,
the support is applied on the base in particular continuously along the longitudinal direction and/or along a transverse direction so as to secure the lower face of the base on the upper face of the support in a non-uniform manner along the longitudinal direction and/or along the transverse direction perpendicular to the longitudinal direction so as to define portions of the base secured to the support, and portions of the base not secured to the support, set formed by the support and the base forming a product.

2. The method according to claim 1, wherein:
the product comprising the support and the base secured in a non-uniform manner to the support is demolded,
all or part of the portions of the base not secured to the support are cut out and separated from the product.

3. The method according to claim 2, wherein said cutout defines at least one edge of the base not secured to the support and is made so as to maintain a non-zero distance between said at least one edge of the base not secured to the support and at least one adjacent portion of the base secured to the support.

4. The method according to claim 2, wherein following the cutting step or simultaneously with the cutting step, the portions of the base cut out and separated from the product are collected, and the material is reused so as to produce the or one base and/or the retaining element(s) and/or the preform(s).

5. The method according to claim 2, wherein following the cutting step or simultaneously with the cutting step, a calendering is performed on all or part of a periphery of portions of the base secured to the support as to secure it or confirm its securing to the support.

6. The method according to-any claim 1, wherein, in particular prior to the cutting step, a calendering of the preforms is performed so as to modify the geometry of all or part of the preforms to obtain retaining elements.

7. The method according claim 1, wherein the base is secured to the support in particular by partial penetration of the support into the base by application of the support on the base downstream of the formation of the base, prior to the solidification of the lower face of the base.

8. The method according to claim 1, wherein the base and the support are made of different materials, especially materials of different natures.

9. The method according to claim 1, wherein the support comprises fibers and/or filaments and/or threads on its upper face, for example the support comprises a web of nonwoven material.

10. The method according to claim 9, wherein the support is calendered per area prior to its application on the base the at least one calendered area of the support, in particular the calendered areas of the support having a thickness at least 10%, preferably at least 30% smaller, the at least one non-calendered area, in particular the non-calendered areas and a surface greater than 5 mm², in particular at least 15 mm² , determining during the application of the support at least one area, in particular areas of greater thickness pressurized on the base which is secured to the base and at least one calendered area, in particular calendered areas of smaller thickness which is not secured to the base.

11. The method according to claim 10, wherein an upper face of the at least one non-calendered area of the support, in particular the non-calendered areas of the support, extends along a non-calendered plane and an upper face of the at least one calendered area of the support in particular calendered areas of the support, extends along a calendered plane distinct from the non-calendered plane, the at least one non-calendered area of the support or the non-calendered areas of the support being intended to be secured to the base and the at least one calendered area of the support or the calendered areas of the support being intended not to be secured to the base.

12. The method according to claim 1, wherein the application of the support on the base is performed in a non-uniform manner, such that the lower face of the support defines:
a first set of areas in which the support is secured to the base,
a second set of areas in which the support is not secured to the base
wherein the first set of areas extends along a first plane and the second set of areas extends along a second plane distinct from the first plane the first plane being closer to the lower face of the base than the second plane.

13. The method according to claim 1, wherein the application of the support on the base is performed by means of a roller having solid portions adapted to apply a force tending to secure the support to the base and hollowed-out areas, configured so as not to apply a force tending to secure the support to the base.

14. A device comprising:
a support, having a lower face and an upper face, the support forming a strip extending along a longitudinal direction,
a base, extending along the longitudinal direction between a first end and a second end, the base having a lower face facing the upper face of the support and an upper face the base having a constant thickness between its lower face and its upper face, in particular over at least 30% of the surface of the base,
a plurality of retaining elements extending from the upper face of the base,
wherein the is secured to the support in a non-uniform manner and comprises at least one segment secured to the support and at least one portion not secured to the support.

15. The device according to claim 14, wherein the base comprises a periphery portion forming an outer periphery of the base extending over a maximum distance of 3 mm, especially 2 mm, especially 1 mm, especially 0.5 mm, wherein at least 3%, especially at least 5%, 7%, 10%, 15%, 20%, 25%, 30%, 35% or 45% of the surface of the periphery portion is not secured to the support and in particular has a thickness substantially equal to the constant thickness of the base and/or of the internal portion of the base.

16. The device according to claim 14, wherein the base comprises a periphery portion forming an outer periphery of the base extending over a maximum distance of 3 mm, especially 2 mm, especially 1 mm, especially 0.5 mm, wherein at least 3%, especially at least 5%, 7%, 10%, 15%, 20%, 25%, 30%, 35%, 45%, 50% or 60% of the surface of the periphery portion is secured to the support and has a thickness smaller than the thickness of an internal portion of the base.

17. The device according to claim 14, wherein the base comprises a periphery portion forming an outer periphery of the base extending over a maximum distance of 3 mm, especially 2 mm, especially 1 mm, especially 0.5 mm, wherein at least 50%, especially at least 55%, 60%, 65%, 70%, 75%, 80%, 85%, 90%, 95% or 100% of the surface of the periphery portion is not secured to the support, and has a thickness substantially equal to the constant thickness of the base and/or of the internal portion of the base in particular the periphery portion not secured to the support has a thickness substantially equal to the constant thickness of the base and/or of the internal portion of the base.

18. The device according to claim 14, wherein the base comprises a periphery portion forming an outer periphery of the base extending over a maximum distance of 3 mm, especially 2 mm, especially 1 mm, especially 0.5 mm, wherein at least 50%, especially at least 55%, 60%, 65%, 70%, 75%, 80%, 85%, 90% or 95% of the surface of the periphery portion is secured to the support and all or part of the periphery portion secured to the support has a thickness smaller than the thickness of an internal portion of the base.

19. The device according to claim 18, wherein 100% of the surface of the periphery portion is secured to the support, part being derived from calendering of the at least one portion not secured to the support and all or part of the periphery portion secured to the support has a thickness smaller than the thickness of an internal portion of the base.

20. The device comprising:
a support having a lower face and an upper face, the support forming a strip extending along a longitudinal direction,
a base, extending along the longitudinal direction between a first end and a second end, the base having a lower face facing the upper face of the support, and an upper face the base having a constant thickness between its lower face and its upper face, in particular over at least 30% of the surface of the base,
a plurality of retaining elements extending from the upper face of the base,
wherein 100% of the surface of the periphery portion is secured to the support and all or part of the periphery portion secured to the support has a thickness smaller than the thickness of an internal portion of the base.

21. The device according to claim 14, wherein the lower face of the support defines:
a first set of areas in which the support is secured to the base,
a second set of areas in which the support is not secured to the base,
wherein the first set of areas extends along a first plane and the second set of areas extends along a second plane distinct from the first plane the first plane being closer to the lower face of the base than the second plane.

22. The device according to claim 16, wherein the periphery portion is devoid of retaining elements.

23. The device according to claim 16, wherein the periphery portion comprises retaining elements.

24. The device according to claim 14, wherein the support comprises fibers and/or filaments and/or threads on its upper face, for example the support comprises a web of nonwoven material.

25. The device according to claim 24, wherein the support comprises calendered areas and non-calendered areas, the calendered areas of the support having a thickness at least 10%, preferably at least 30%, smaller than the non-calendered areas and a surface greater than 5 mm² , in particular at least 15 mm² , such that an upper face of the non-calendered areas of the support extends along a non-calendered plane P1′ and an upper face of the calendered areas of the support extends along a calendered plane P2′ distinct from the non-calendered plane P1′, the non-calendered areas of the support being secured to the base and the calendered areas of the support not being secured to the base.

26. The device according to claim 14, wherein the base is secured to the support by partial penetration of the support into the base.

27. The device according to claim 14, wherein the base and the support are made of different materials, especially materials of different natures.

28. The device according to claim 14, wherein the base has a variable width along the transverse direction.

29. The device according to claim 14, wherein the base is included in an area delimited by two parallel straight lines extending along the longitudinal direction, and wherein an occupancy rate of the base in this area is strictly less than 100%, preferably less than 95%, especially less than 80% and/or greater than 5%, especially greater than 15%, more particularly greater than 35%, in other cases greater than 50%.

30. The device according to claim 11, wherein a maximum dimension of the base along a row along the longitudinal direction is smaller less than the maximum dimension of the support along the longitudinal direction.

31. The device according to claim 14, wherein the support comprises at least one notch or cutout formed in a portion of the support distant from the edges of the support in particular the at least one notch or cutout is formed in the support on the periphery of the edge of the base, especially at more or less 3 mm from the border of the base, in particular at more or less 2 mm from the border of the base.

32. The device according to claim 14, comprising a reference means for the cutting, for example a marking, a hole, an embossing and/or an ink layer.

33. A system comprising a device according to claim 14, and a complementary base in particular extending along the longitudinal direction, the complementary base having an upper face and a lower face, the lower face being devoid of retaining elements.
